(19) United States
(12) Patent Application Publication
(10) Pub. No.: US 2004/0217855 A1
(43) Pub. Date: Nov. 4, 2004

(54) Warning means on car body above car wheels

(76) Inventor: Wen-Hsu Wang, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/425,866

(22) Filed: Apr. 30, 2003

(51) Int. Cl. B60Q 1/26

(52) U.S. Cl. 340/468

(57) ABSTRACT

The present invention is to solve the problem of lacking a light source on the lateral sides of a car body as is the case of conventional car bodies; in which a warning means is provided on a haunch portion on a lateral side of a car body above a wheel of a car, the warning means comprises: a base fixed on a lateral side of the haunch portion; a light emitting means connected to the base and electrically controlled by a controlling switch; and a transparent hood covering the base. A light beam penetrates the transparent hood to generate a bright indication and warning effect when the warning means emits light.

### BACKGROUND OF THE INVENTION

1. Field of the Invention

This present invention relates to warning means on the haunch portions of a car above the wheels of a car, and more particularly to warning means on the haunch portions above the wheels of a car to give a light to get an effect of warning.

2. Description of the Prior Art

Common traffic vehicles such as trucks, automobiles, motorcycles, bicycles, baby strollers etc. have their warning lights provided on the front and rear ends of them; when the warning lights are lightened, only the front and rear ends emit light to achieve the functions of indicting turning right or left, braking, safety warning and illumination etc. However, there is no any light emitting means on either lateral side of such a vehicle, when two vehicles are meeting or driving side by side, they are not easy to keep a safe distance from each other, particularly when at night, in a raining or foggy day or in a storm or in a tunnel with inferior sight; moreover, when in driving to pass another car, the front car is uneasy to be aware from a rearview mirror of whether the rear car is to pass, because the rear car has no light-emitting source on the lateral sides thereof.

To overcome the stated problem, a safety warning effect can only be obtained for making a driver see clearly a light-emitting source provided evidently on either side of a car so as to keep an appropriate distance therefrom; in this view, some manufacturers developed strips providing cool light or reflective decoration strips for preventing collision at the edges of car doors. However, whichever the light-emitting source is, the position it is located makes it emit light as a single point or in a partial mode, such as the single-point light emitting of a rearview mirror or the partial light emitting from a car door etc. By the fact that a car body has quite a length, it is unable to show the entire length of the car by single-point or partial light emitting, and these modes of light emitting are not quite perfect.

### SUMMARY OF THE INVENTION

In order to solve the abovementioned problems, the present invention is provided on the haunch portions on both lateral sides of a car body above the car wheels with warning means, each warning means comprises: a base fixed on the lateral side of a haunch portion above a car wheel, a light emitting means connected to the base and electrically controlled by a controlling switch and a transparent hood covering the base. When the light emitting means emits light, a light beam can penetrate the transparent hood to generate a bright indication and warning effect.

The present invention can get the following results when in practice:

1. The warning means is provided on a haunch portion on a lateral side of a car body above a front and a rear wheel of the car, the front and the rear section of the car body can thereby give a light-emitting source when the warning means is lightened to show the entire lateral side of the car body.

2. The warning means can get the effects of indicating turning right or left and giving warning, so that two cars can keep an appropriate safe distance from each other.

3. The haunch portions on both lateral sides of a car body can be prevented from rusting.

4. The haunch portions with warning means on both lateral sides of a car body are the positions giving the best sight, so that the position and direction of a car can be more clearly known by a driver in the other car.

5. The warning means added above a car wheels can increase the esthetic appearance of the car.

6. The warning means can increase the safety of persons in getting in and off the car against collision by a car passing by.

7. A car body does not need replacement in mounting the present invention on any haunch portion of the car body above a wheel.

8. If the rear lamps on a car are inadvertently broken down and are impossible to fix at once, the added warning means on a haunch portion of the car body can be helpful and guarantee safety.

The present invention will be apparent after reading the detailed description of the preferred embodiments thereof relating to a car and a motorcycle in reference to the accompanying drawings.

### BRIEF DESCRIPTION OF THE DRAWINGS

FIG. 1 is a schematic perspective view of the present invention;

FIG. 2 is a perspective view of the present invention;

FIG. 3 is a sectional view taken from FIG. 2;

FIG. 4 is another perspective view of the present invention;

FIG. 5 is a sectional view taken from FIG. 4;

FIG. 6 is a perspective view of the present invention after assembling;

FIG. 7 is a circuit diagram of the warning means of the present invention;

FIG. 8 is a schematic perspective view showing a further embodiment of the present invention.

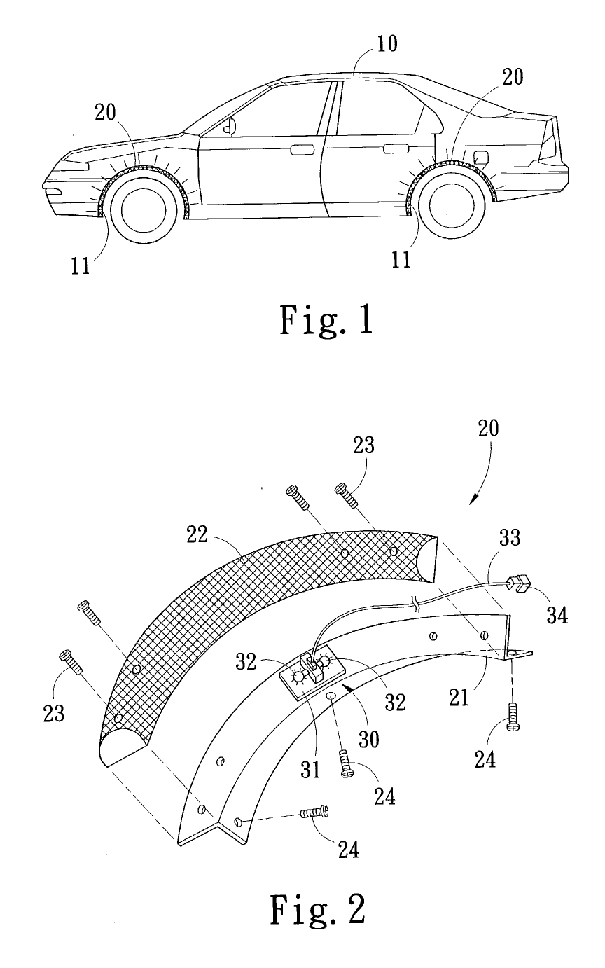

### DETAILED DESCRIPTION OF THE PREFERRED EMBODIMENT

As shown in FIG. I which is a schematic perspective view showing two warning means of the present invention used on haunch portions of one lateral side of a car body, it is depicted in the drawing that the haunch portions 11 above the four wheels 10 of the car are fixedly provided with warning means 20 with the function of emitting light, thereby, a driver can see clearly at night or at a site with inferior sight, the car can keep an appropriate distance from other cars to get an effect of safety driving. The structure of each of the warning means 20 is as shown in FIG. 2, it has a curved base 21, a light emitting means 30 connected to the base 21 and a transparent hood 22 covering the base 21. Wherein the light emitting means 30 has a lamp seat 31 mounted therein a lamp bulb 32; the lamp seat 31 is connected with a power source line 33 extending outwardly to connect with a connector 34. The light emitting means 30 can alternatively be provided, as is shown in FIG. 4, with an electric circuit board 35 having a plurality of LED's 36 and IC's 37 etc., the electric circuit board 35 connects with the power source line 33 which also extends outwardly to connect with a connector 34.

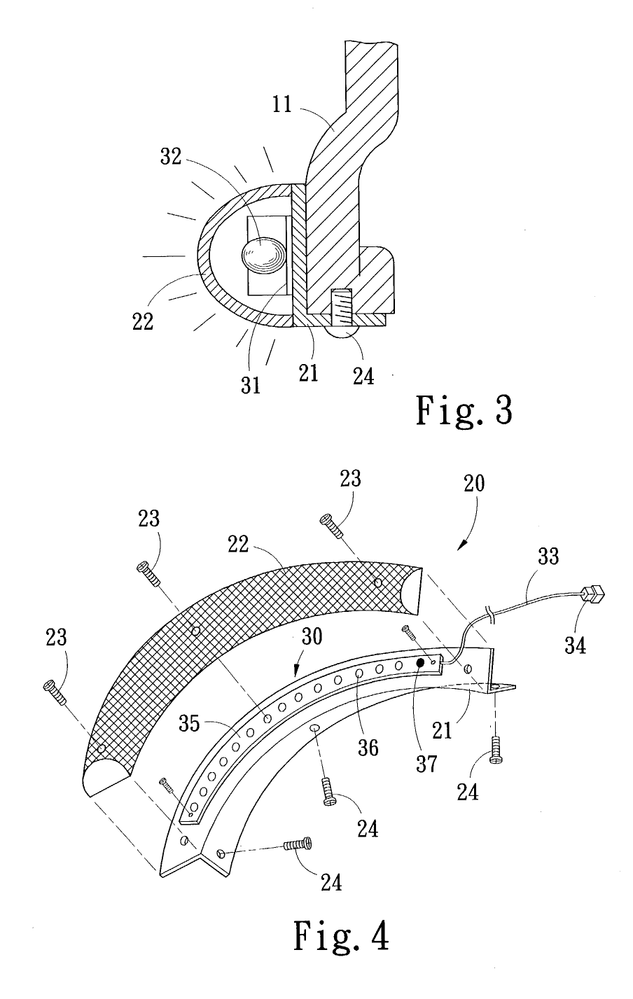

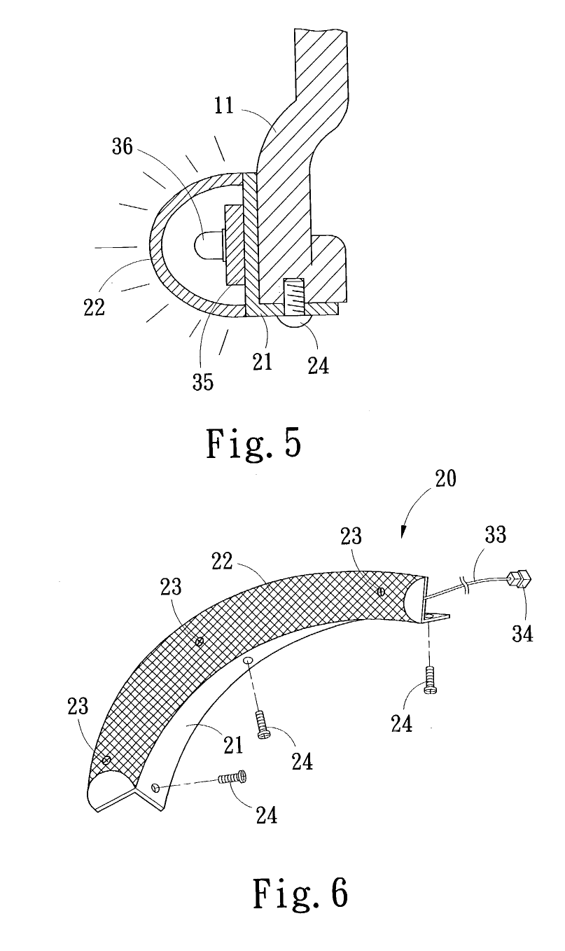

The transparent hood 22 is fixed on the base 21 with screws 23; the structure of the warning means 20 after assembling is shown in FIG. 6, the warning means 20 is mounted onto the haunch portions 11 of the car by locking with screws 24, adhesive, hot plastisol, or by welding etc., the structure of the warning means 20 after mounting is shown in FIGS. 3 and 5.

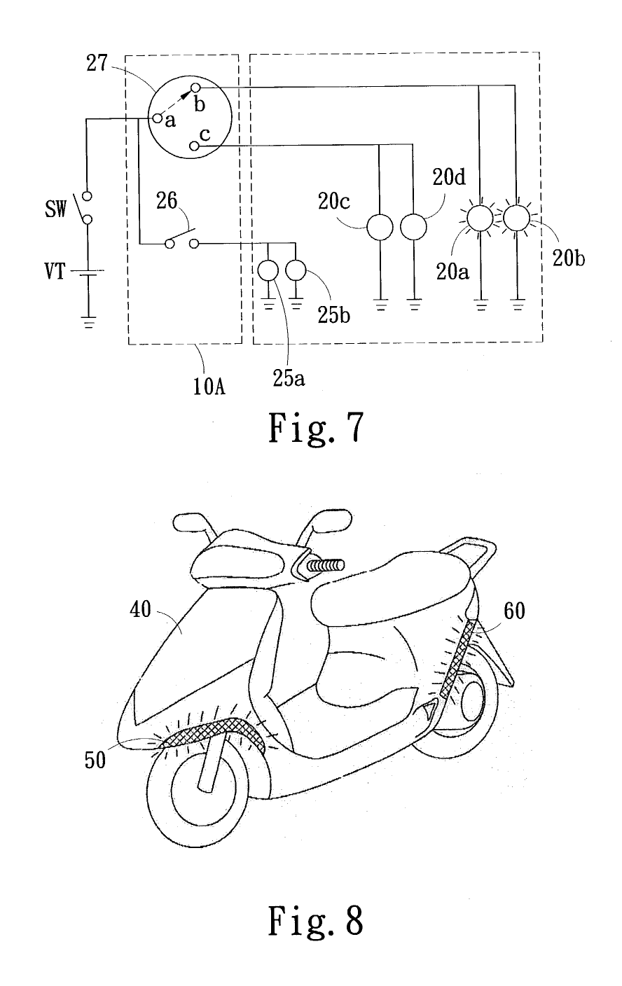

FIG. 7 shows a circuit diagram of the warning means of the present invention, when an electric cell or a battery VT is activated via a car switch SW, and a change-over switch 27 makes tapping by change of direction of the electric current, the warning means 20 on the car body will then emit light.

As an example, when the change-over switch 27 is moved from a point “a” to a point “b”, the front and the rear warning means 20a, 20b on the right lateral side of the car body emit light. On the contrary, when the change-over switch 27 is moved from the point “a” to a point “c”, the front and the rear warning means 20c, 20d on the left lateral side of the car body emit light.

And more, two miniature night lights 25a, 25b are added to the interior of the front and the rear warning means 20a, 20b (four warning means above the four wheels of the car can be all mounted therein with miniature night lights), a switch 26 is provided to keep the miniature night lights lightened or turned off.

FIG. 8 is a schematic perspective view showing warning means of the present invention further being used on haunch portions of the body of a motorcycle, it is depicted that the body of the motorcycle 40 is provided on the two lateral sides thereof respectively with front warning means 50 and rear warning means 60, the structures of the warning means 50 and 60 are same as those of the warning means 20 as stated in the precedent paragraphs, and no further description is required here.

Although this invention has been disclosed and illustrated with reference to some particular embodiments, the principles involved are susceptible for use in numerous other embodiments which will be apparent to persons skilled in the art. The invention is, therefore, to be limited only as indicated by the scope of the appended claims.

1. A warning means on a haunch portion on a lateral side of a car body above a wheel of a car or on a wheel cover, said warning means comprises:
a base fixed on a lateral side of said haunch portion;
a light emitting means connected to said base and electrically controlled by a controlling switch; and
a transparent hood covering said base, a light beam penetrates said transparent hood to generate a bright indication and warning effect when said warning means emits light.

2. The warning means as claimed in claim 1, said warning means is characterized by that, said light emitting means comprises a lamp seat and a lamp bulb mounted in said lamp seat; said lamp seat is connected with a power source line extending outwardly to connect with a connector.

3. The warning means as claimed in claim 1, said warning means is characterized by that, said light emitting means is provided with an electric circuit board having a plurality of LED's and IC's, said electric circuit board connects with a power source line which extends outwardly to connect with a connector.

4. The warning means as claimed in claim 2, said warning means is characterized by that, a miniature night light is added to the interior of said warning means.
